(19) United States
(12) Patent Application Publication
(10) Pub. No.: US 2004/0055405 A1
(43) Pub. Date: Mar. 25, 2004

(54) Synchronizing system

(76) Inventor: Jorg Schwarzbich, Bielefeld (DE)

Correspondence Address: RICHARD M. GOLDBERG, 25 EAST SALEM SREEET, SUITE 419, HACKENSACK, NJ, 07601, US

(21) Appl. No.: 10/658,875

(22) Filed: Sep. 10, 2003

(30) Foreign Application Priority Data
Sep. 19, 2002 (DE) 202 14 485.2
Nov. 6, 2002 (DE) 202 17 216.3

(51) Int. Cl. F16H 3/38

(52) U.S. Cl. 74/339

(57) ABSTRACT

Synchronizing system for manual transmissions, having a gear (12), a shift sleeve (14) which is in displaceable engagement with the gear (12) through internal teeth (16), and thrusters (26; 26′; 26″; 26′″) having each a pot-like casing (32) received in an axial slot (24) in the gear (12) and having a spring (34) which thrusts against the internal teeth (16) of the shift sleeve (14) and biases a pressure member (28) against the internal teeth (16), characterized in that the casing (32) of the thruster (26; 26′; 26″; 26′″) is supported so as to be able to tilt on the bottom of the slot (24) of the gear (12).

The invention relates to a synchronizing system for manual transmissions, having a gear, a shift sleeve which is displaceably in engagement with the gear, and with thrusters arranged between the gear and the shift sleeve which have each a box-like casing held in an axial groove in the gear, and a spring which is supported on the bottom of the thruster casing and biases a detent against the internal teeth of the shift sleeve.

Synchronizing systems serve in manual transmissions for producing a synchronism between two gears mounted on a common shaft before a driving connection is produced between these gears. For this purpose a synchronizing ring is provided between the drive gear on the shaft and the driven gear mounted for rotation on the shaft, and can be urged into frictional engagement with the driven gear. When the shift sleeve on the driving gear is shifted toward the driven gear, its internal teeth run first against beveled teeth of the synchronizing ring, so that a frictional face of the synchronizing ring is urged against the driven gear. As long as the rotatory speed of the driving and driven gears are not the same, the torque exerted by the friction produced by the contact with the synchronizing ring prevents any further displacement of the shift sleeve. Only when the rotary speeds are equal can the synchronizing ring rotate relative to the shift sleeve to a position wherein the shift sleeve can be shifted against external teeth on the driven gear, so that the driven gear is coupled torsionally to the driving gear. The thrusters arranged between the driving gear and the shift sleeve eliminate the free play between the driving gear and the shift sleeve and thus contribute to the reduction of noise and wear.

In DE 195 80 558 C1 a synchronizing system of this kind is described, in which the axial grooves serving to accommodate the thrusters have a T-shaped profile. The housings of the thrusters have a shape complementary to this profile and are supported on the shoulders of the T-shaped groove near the end that is provided with the thruster. Thus the thrusters are guided for displacement in the grooves. The thrusters are biased by the springs into recesses in the internal teeth of the drive gear. When the shift sleeve is shifted the thrusters are first carried a short distance until they abut against the synchronizing ring. Only then are the thrusters forced back against the force of the spring, so that the shift sleeve can be shifted further by overcoming the slight resistance of a catch. The manufacture of the T-shaped grooves, however, is relatively expensive. Moreover, a relatively great amount of space is required to accommodate the thrusters, and due to the grooves widened at the radially outer ends the external teeth of the gear are interrupted on a relatively great circumferential length. Furthermore, as the thrusters shift, friction and wear occur because the widened heads of the casings are driven by the springs with great force against the shoulders of the T-slots.

It is therefore the object of the invention to create a synchronizing system, which can be manufactured more easily, will permit a compact construction of the synchronizing system, and permit easy movement of the shift sleeve.

This object is achieved by the fact that the casing of the thruster is supported in such a manner as to be able to tilt on the bottom of the groove in the gear.

Upon the movement of the shift sleeve, the casings of the thrusters are thus not shifted as a whole relative to the gear, but only rocked slightly on their radially interior ends, so that they do not hamper the movement of the shift sleeve. At the same time, this design permits the grooves in the gear to be made narrower and with a simple rectangular profile. Accordingly, the thruster casings can also have a simpler form and smaller dimensions circumferentially about the gear.

Advantageous embodiments of the invention are described in the sub-claims.

The casing of the thruster is preferably made of plastic and at the end, which receives the thruster, a ball catch for example, an abutment is formed which secures the ball catch against escape. The bottom of the casing is preferably slightly rounded, so that it can roll on the bottom of the groove in the gear during the tilting movement.

The thruster casing can be in the shape of a square post, but optionally it can be slightly thicker at its radially outer end in the axial direction of the gear. If a thruster casing is in the shape of a square post, the bottom can be rounded spherically, so that the casing can be inserted into the groove in the gear optionally in positions rotated 90° away from one another. In this manner errors are avoided when equipping the gear with the thrusters.

Preferably, the thruster casing has extensions at its radially outer end, which engage the gaps between the internal teeth of the shift sleeve. In this case, in the event that the spring of the shift sleeve breaks, or the catch body is lost or jams, the shift sleeve can be still supported by the projections of the casing, so that even in this case any chattering between the shift sleeve and the gear can be prevented.

Embodiments of the invention are described hereinafter with the aid of the drawing, in which

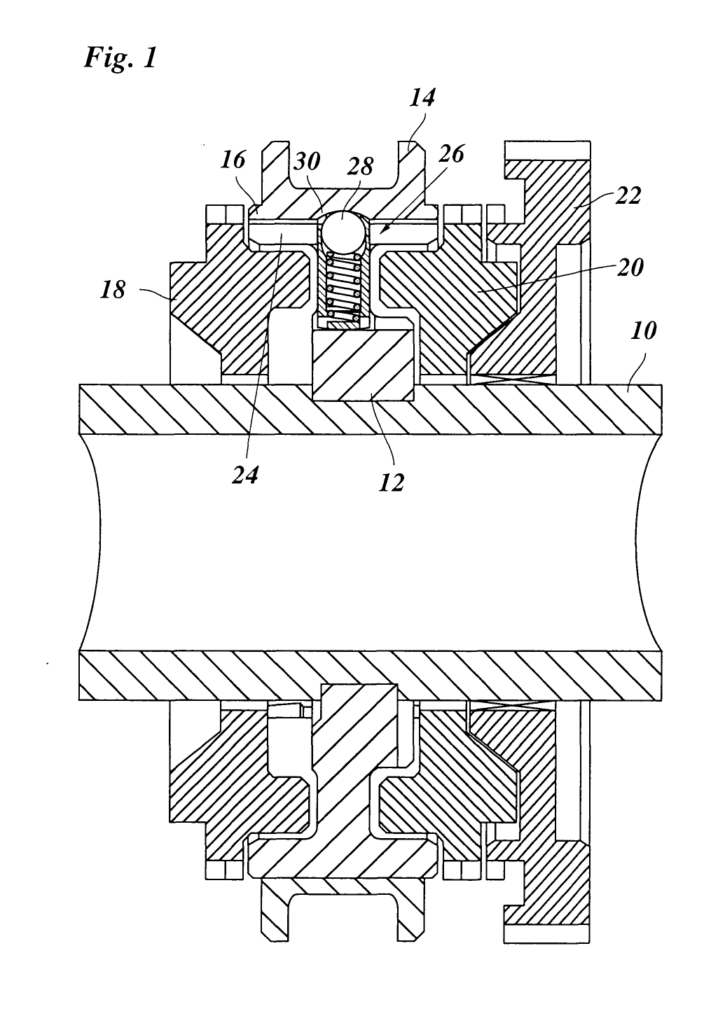

FIG. 1 shows a section through a synchronizing system in the neutral position,

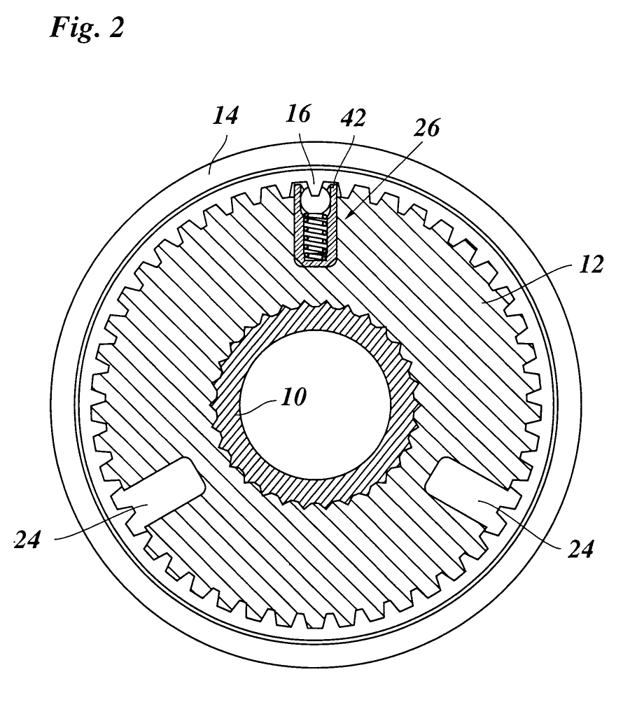

FIG. 2 shows a view of a shift sleeve on a gear provided with thrusters and represented in section,

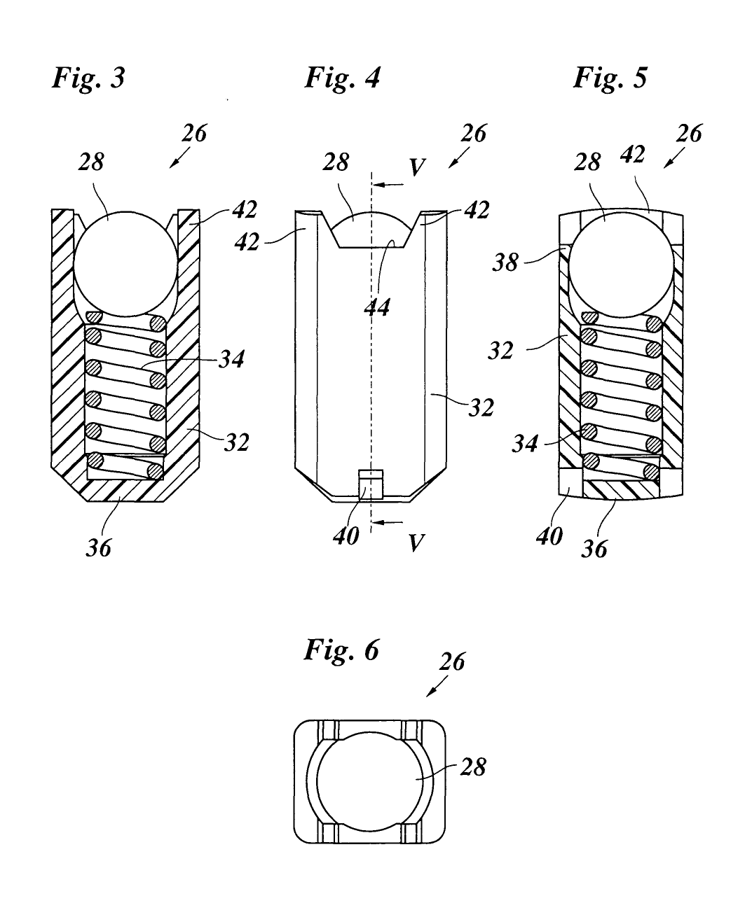

FIG. 3 shows an enlarged sectional representation of the thrusters from FIG. 2,

FIG. 4 shows a side view of the thruster,

FIG. 5 shows a section taken along line V-V in FIG. 4,

FIG. 6 shows a thruster in a plan view;

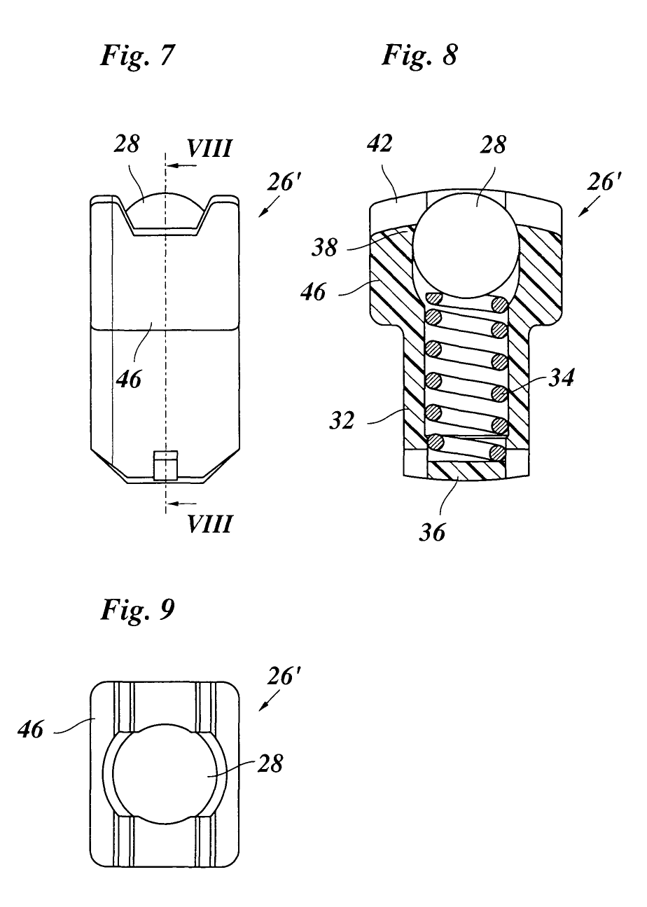

FIGS. 7 to 9 show a side view, a longitudinal section and a plan view of a thruster of another embodiment;

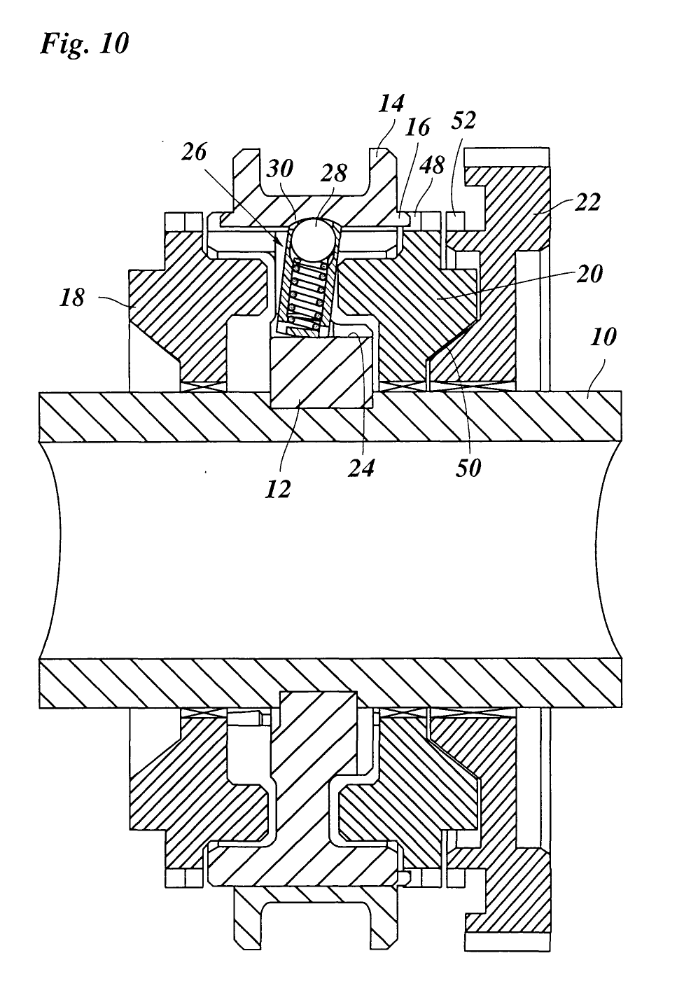

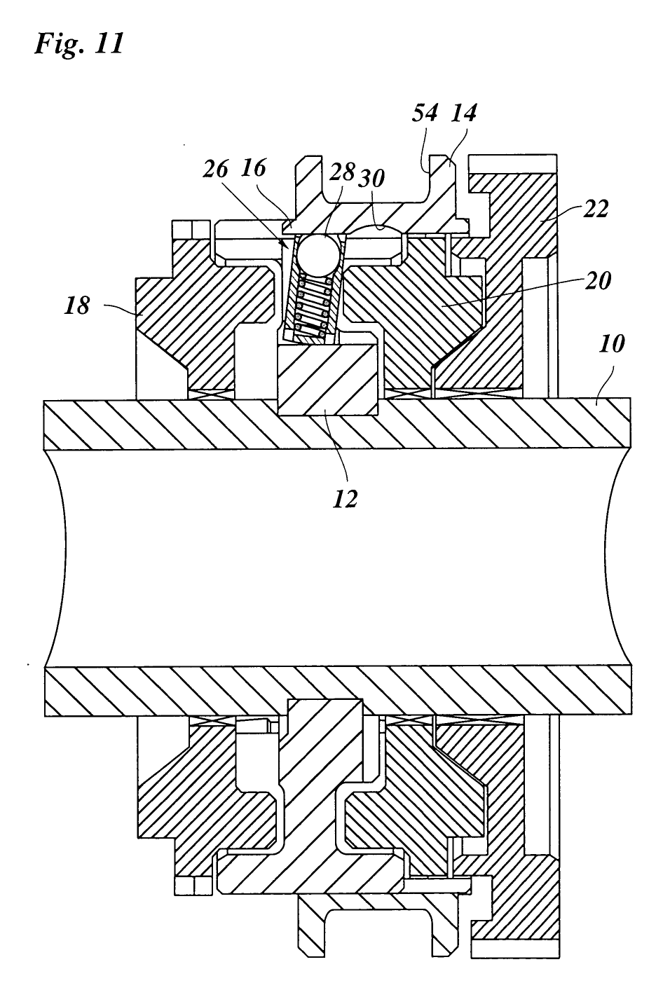

FIGS. 10 and 11 show sectional drawings similar to FIG. 1 for different positions of the synchronizing system, and

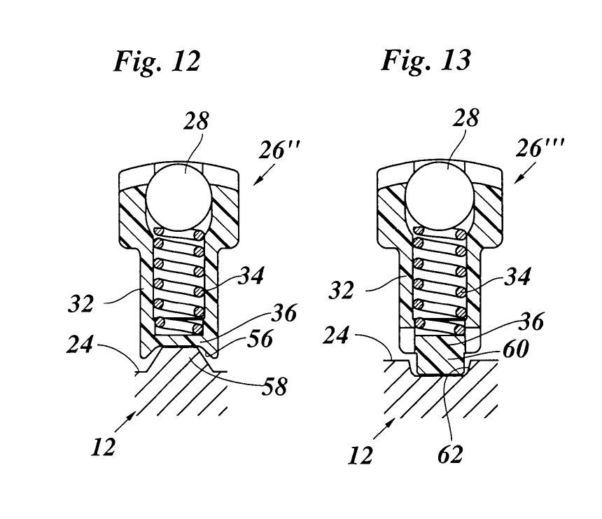

FIGS. 12 and 13 show longitudinal sections of two thrusters of two additional embodiments.

FIG. 1 shows a gear 12 splined on a shaft 10 and surmounted by a shift sleeve 14. With internal teeth 16 the shift sleeve engages the teeth of the gear 12 and is displaceable on the gear in the axial direction of the shaft 10.

On both sides of the gear 12 and the shift sleeve synchronizing rings 18 and 20 are arranged which rotate together with the gear 12 and the shift sleeve 16, but are able to rotate relative to the gear 12 within a limited angular range. On the side of synchronizing ring 20 opposite the gear there is shown a gear 22 which is mounted for rotation on the shaft 10 and can be coupled by the shift sleeve 14 to the gear 12 to rotate with the latter. On the side of the other synchronizing ring 18 facing away from the gear 12 there is an additional gear with a different diameter, which is not shown. By the displacement of the shift sleeve 14 in one or the other direction, either the gear 22 or the additional gear not shown can be driven by the shaft 10, so that different ratios can be established in the transmission.

As it can be seen in FIG. 2, the gear 12 has in its outer circumference three slots 24 which are continuous in the axial direction, and are arranged at 120° apart; they have an elongated cross section in the radial direction and interrupt the external teeth of the gear 12 at the point of a single tooth. Thrusters 26 are inserted into the slots 24, only one of which is shown in FIG. 2. In FIG. 1 the section plane passes through the upper slot 24 into which the thruster 26 is inserted. The thruster 26 bears a ball which is referred to hereinafter as detent ball 28 and which is resiliently biased radially outward and, as FIG. 1 shows, it engages a shallow, trough-like recess 30 formed in one of the teeth of the shift sleeve 14.

The thruster 26 is shown in greater detail in FIGS. 3 to 6. It has a box-like thruster casing 32 formed by a plastic molding, which is in the shape of a rectangular, approximately square post. In the sectional drawing of FIG. 3 and the elevation in FIG. 4 the casing 32 has a width which corresponds to the width of the slots 24. In the direction perpendicular thereto (sectional drawing of FIG. 5) the width of the casing is slightly smaller. Inside of the casing a cylindrical bore is formed which accommodates a spring 34. The spring 34 is supported on the bottom 36 of the thruster casing 32 and biases the detent ball 28 upwardly against the shift sleeve. The detent ball 28 is contained for displacement in an expanded upper portion of the bore, but is permanently held in the casing against escape by slight crimping 38 on the somewhat thinner walls of the casing 32 shown in section in FIG. 5. During assembly the detent ball 28 can thus be snapped into the casing 32, so that the thruster can then be inserted as a preassembled unit into the gear 12. Near the bottom 36 of the casing holes 40 (FIG. 5) are provided for drainage of transmission oil.

As it is furthermore to be seen in FIG. 5, the bottom 36 of the thruster casing 32 is slightly rounded.

The walls of the thruster casing 32 shown in section in FIG. 3 form projections 42 which protrude above the crimps 38 and thus define an opening 44 (FIG. 4) which can be engaged by a tooth provided with the recess 30 on the shift sleeve 14.

FIGS. 7 to 9 show the thruster 26′ which differs from the thruster 26 previously described, in that the casing 32 has on the radially outer (upper in FIGS. 7 to 8) end a thickened head 46 of longitudinal rectangular plan which extends in the direction of the axial slot 24. In this manner a better guidance of the casing 32 in the slot 24 is obtained, and at the same time greater rigidity in the crimps 38.

On both of the thrusters 26 and 26′ the projections 42 are rounded at the top, as it can be seen in FIGS. 5 and 8. The rounding corresponds to an arc that is concentric with the bottom crest of the rounding of the bottom 36.

The manner of the operation of the synchronizing system is now to be explained with the aid of FIGS. 10 and 11.

In FIG. 10 the shift sleeve 14 is shifted slightly rightward in comparison with FIG. 1, so that the internal teeth 16 run on slopes of external teeth of 48 of the synchronizing ring 20. In this movement of the shift sleeve 14 the thruster 26 is rocked over about its bottom end which rests on the bottom of the slot 24. This rocking is facilitated by the rounding of the bottom 36 of the casing 32. Due to this tilting movement the ball detent 28 remains engaged with the recess 30 of the shift sleeve. In the state shown in FIG. 10, the tilting of the thruster 26 is limited by the fact that its casing 32 collides with the synchronizing ring 20.

In the movement of the shift sleeve 14 between the positions shown in FIGS. 1 and 10 there is thus no need to overcome any frictional resistance, since the thrusters 26 act equally as joints which permit the relative movement between gear 12 and shift sleeve 14 and at the same time always allow for free play.

The synchronizing ring 20 in the state shown in FIG. 10 has been shifted by a conical friction surface against an external taper 50 of gear 22, so that gear 22 is accelerated or retarded by friction to the rotatory speed of the unit formed by gear 12, shift sleeve 14 and synchronizing ring 20. As long as equality of speed is not reached, the tooth slopes of the external teeth 48 of the synchronizing ring 20, which is then still subject to a high torque, offer so much resistance to the movement of the shift sleeve 14 that the internal teeth 16 still cannot be brought into engagement with external teeth 52 of gear 22. Not until the speeds become equal can the shift sleeve 14 be shifted further into the position shown in FIG. 11, in which it produces a coupling action between gears 12 and 22. Since the detent ball 28 can no longer participate in this further movement of the shift sleeve 14, it is forced out of the recess 30 in the shift sleeve against the force of the spring 34. When gear 22 is coupled with gear 12 a detent resistance produced by the thrusters 26 has to be overcome.

Furthermore, the movement of the shift sleeve 14 is controlled by a shift fork not shown, which engages the groove 54 on the outer circumference of the shift sleeve. The shift sleeve is also held in the positions shown in FIGS. 1 and 11 by this shift fork.

By the rounding of the projections 42 of the casing 32 of the thruster 26, and especially of thruster 26′, it is assured that the casing will not collide against the internal teeth 16 of the shift sleeve due to the tilting movements, so that only the detent ball 28 comes in contact with the shift sleeve. As shown in FIG. 2, however, the projections 42 reach so far into the gaps between the internal teeth 16 that the casing 32 of the thruster 26 can act also independently of the detent ball 28 as a spacer between the gear 12 and the shift sleeve 14, and thus it prevents tooth chatter in case of a broken or excessively weak spring 34.

In a modified embodiment of the thruster 26, which is not shown, the plan of its casing 32 can also be precisely square, and in the casing walls which form the projections 42, recesses similar to recesses 44 can be provided. In this case the thruster 26 is spherically rounded on its bottom 36 and has a generally 90° symmetry about its longitudinal axis, so that it can be inserted into groove 24 in any desired position.

Since the slots 24 of the gear are continuous in the axial direction, the thrusters 26 and 26′ are easy to install. Although the slots 24 are open at both ends the thrusters cannot drop out because they are secured in position by the synchronizing rings 18 and 20.

FIGS. 12 and 13 show thrusters 26″ and 26′″ which differ from the thrusters 26 and 26′ in that they are secured at their bottom 36 against slipping in the slot 24 of the gear 12. The thruster 26″ has a recess 56 which is engaged by a projection 58 protruding from the bottom of slot 24. The thruster 26′″ has a projection 60 which engages a groove 62 on the bottom of slot 24 of gear 12. The projections 58 and 60 and recesses 56 and 62 are matched to one another such that they permit the tilting of the thruster in the plane of drawing of FIG. 12 and FIG. 13.

1. Synchronizing system for manual transmissions, having a gear (12), a shift sleeve (14) which is displaceably engaged with the gear (12) by internal teeth (16), and having thrusters (26; 26′; 26″; 26′″) disposed between the gear (12) and the shift sleeve (14), which have each a box-shaped casing (32) and a spring (34) held in an axial slot (24) of the gear (12) and resting on the bottom (36) of the casing (32), and a pressure member (28) biased against the internal teeth (16) of the shift sleeve (14), characterized in that the casing (32) of the thruster (26; 26′; 26″; 26′″) rests while able to tilt on the bottom of the slot (24) of the gear (12).

2. Synchronizing system of claim 1, characterized in that the pressure member (28) is a catch which engages a recess (30) in the internal teeth (16) of the shift sleeve (14).

3. Synchronizing system of claims 1 or 2, characterized in that the casing (32) of the thruster (26; 26′) is a body molded from plastic.

4. Synchronizing system of one of the preceding claims, characterized in that the pressure member (26) is held in the casing against loss by crimps (38) formed on the walls of the casing (32).

5. Synchronizing system of one of the preceding claims, characterized in that the bottom (36) of the thruster casing (32) is rounded.

6. Synchronizing system of one of the preceding claims, characterized in that the thruster casing (32) forms projections (42) on the radially outer ends, which reach into the spaces between the internal teeth (16) of the shift sleeve (14).

7. Synchronizing system of claim 6, characterized in that the projections (42) are rounded at the free end, the rounding corresponding to an arc centered on the radially inner end of the thruster (26; 26′).

8. Synchronizing system of one of the preceding claims, characterized in that the casing (32) of the thruster (26) is in the shape of a square or rectangular post.

9. Synchronizing system of claim 8, characterized in that the thruster (26) has a 90° plane of symmetry with respect to its longitudinal axis.

10. Synchronizing system of one of the claims 1 to 7, characterized in that the casing (32) of the thruster (26′) has at the radially outer end a thickened head (46) of rectangular plan which extends in the lengthwise direction of the slot (24).

11. Synchronizing system of one of the claims 1 to 10, characterized in that the bottom of the casing (32) of the thruster (26″, 26′″) and the bottom of the slot (24) are conformed to one another over contoured surfaces (56,58; 60,62).

12. Synchronizing system of claim 11, characterized in that the casing (32) of the thruster (26″) has a recess (56) which is engaged by a projection (58) formed on the bottom of the slot (24).

13. Synchronizing system of claim 11, characterized in that the casing (32) of the thruster (26″) has a projection (60) on its bottom which engages a recess (62) in the bottom of the slot (24).
